(19) United States
(12) Patent Application Publication
(10) Pub. No.: US 2006/0045000 A1
(43) Pub. Date: Mar. 2, 2006

(54) Time-frequency interleaved mc-cdma for quasi-synchronous systems

(75) Inventors: Celine Morlier, Paris (FR); Antoine Chouly, Paris (FR); Berna Unal Sayrac, Paris (FR)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/521,132

(22) PCT Filed: Jul. 8, 2003
(86) PCT No.: PCT/IB03/03136

§ 371 Date: Jan. 12, 2005

(30) Foreign Application Priority Data
Jul. 17, 2002 (EP) 022918023

(51) Int. Cl. H04J 11/00; H04J 13/00

(52) U.S. Cl. 370/203

(57) ABSTRACT

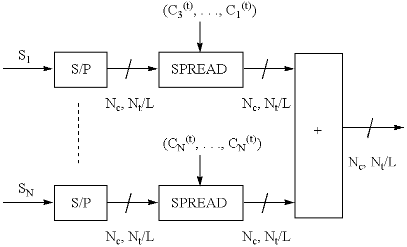

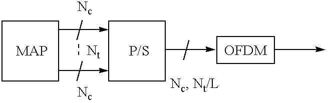

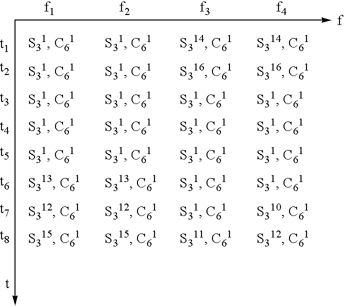

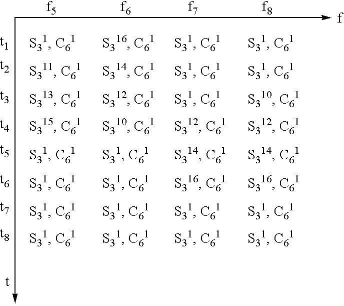

The invention relates to digital transmissions. It particularly relates to a method of transmitting data from a transmitter to a receiver using multi-carrier Code Division Multiple Access (CDMA) for accessing a transmission system. The transmitted data are OFDM modulated using Orthogonal Frequency Division Multiplexing (OFDM) after being spread with a set of predefined spreading sequences of consecutive chips, wherein two successive chips of the predefined sequences are transmitted on non-successive carriers and in non-successive time intervals.

### FIELD OF THE INVENTION

The invention generally relates to digital transmissions. In particular, it relates to a method of transmitting data using multi-carrier Code Division Multiple Access (CDMA) for accessing a transmission system and to a method of receiving such transmitted data.

The invention also relates to a transmission system, to a transmitter and to a receiver for carrying out the methods mentioned above.

It also relates to computer program products for carrying out such methods.

The invention generally applies to digital multi-user (multiple access) transmission systems and particularly to wireless and radio mobile communication systems such as e.g. next generation high data rate mobile communications systems (beyond 3^{rd} Generation).

### BACKGROUND OF THE INVENTION

Due to the increasing demand for higher rate mobile data communications, the next generation cellular wireless systems, also called 4G systems, have the important challenge of providing high-capacity spectrum-efficient services to the customers. Therefore, even before the full commercial deployment of 3G (3^{rd} Generation) systems, studies and discussions on 4G systems (or IMT-2010+ systems) have already started. Efforts are being made to develop an air interface that supports the requirements of the increasing mobile data traffic.

Wideband Code Division Multiple Access (CDMA) systems have been proposed for wireless communication networks. These systems provide higher average capacity and data rates than conventional multiple access techniques while spreading the data to be transmitted with predetermined spreading sequences. Moreover, they are able to cope with the asynchronous nature of multimedia data traffic and enable combating the hostile channel frequency selectivity. However, the large frequency bandwidth of such high-speed wireless links makes them susceptible to Inter Symbol Interference (ISI). Therefore, a number of multi-carrier CDMA techniques have been suggested to improve performance over frequency selective channels. Multi-carrier CDMA combines the multiple access and cell reuse technology of CDMA systems with the robustness against channel selectivity of multi-carrier systems using Orthogonal Frequency Division Multiplexing (OFDM). It is expected to be a major candidate for the physical layer of the 4G radio mobile system. Spreading can be performed either in the frequency domain, leading to Multi-Carrier CDMA (MC-CDMA), or in the time domain, leading to Multi-Tone CDMA (MT-CDMA) and Multi-Carrier Direct Sequence CDMA (MC-DS-CDMA).

The article by Hikmet Sari: “A Review of Multi-carrier CDMA”; published in the manual “Multi-Carrier Spread-Spectrum & Related Topics” by K. Fazel and S. Kaiser, Kluwer Academic Publishers, 2002, pages 3-12, mentions a system, which combines two variants of multi-carrier CDMA systems, called “the two extremes”, wherein signal spreading is performed either purely in the frequency domain, that is the MC-CDMA system, or in the time domain, that is the MC-DS-CDMA system, respectively. The combined system enables to create diversity both in the time domain and in the frequency domain, by transmitting the chips of a given symbol on a different carrier and in a different chip period.

Though the performance of this system may be better than the “two extremes” mentioned, it is still not optimal with respect to quality (low interference and synchronism) upon reception.

### SUMMARY OF THE INVENTION

It is an object of the invention to provide a system, which yields a better quality upon reception.

The invention takes the following aspects into consideration. Coherent detection upon reception is facilitated if the data sent from various transmitters are received synchronously. In uplink transmissions, synchronism upon reception is very hard to obtain since the various users are generally not synchronized.

Therefore, the invention proposes a transmission scheme, which is more robust to quasi-synchronism than the systems mentioned. To this end, a method is proposed of transmitting data symbols using multi-carrier Code Division Multiple Access (MC-CDMA) for accessing a transmission system, the method comprising:
spreading the data symbols with a set of predefined spreading sequences of successive chips for producing sequences of spread data symbols including the data symbols multiplied by the chips,
mapping the spread data symbol sequences so that they are assigned to selected sub-carriers among a set of predefined sub-carriers and to selected time slots in a predefined periodic time interval,
modulating the mapped spread data symbol sequences using Orthogonal Frequency Division Multiplexing (OFDM) for producing OFDM modulated symbols to be transmitted on the selected sub-carriers and in the selected time slots,
   wherein two successive spread data symbols are assigned to non-successive sub-carriers and in non-successive time slots.

De-spreading upon reception after demodulation of the received OFDM symbols leads to easily retrieving the expected encoded data sent by various users, whether synchronous or quasi-synchronous, since spreading sequences allocated to the various users are supposed to be near-orthogonal, which implies that the correlation between non-successive spread data symbols of two distinct users is nearly zero. This allows finding the term representing the encoded data sent by each distinct user.

The transmission scheme of the invention is also more robust to channel selectivity both in time and frequency, since the spread data sequences are distributed over on non-successive sub-carriers and time slots. Advantageously, this allows reducing interference upon reception and leads to better performance.

It is possible to use a unique scheme for uplink and downlink transmissions. Only the mapping needs to be adapted to the system under consideration.

By varying selected parameters, the invention also provides higher flexibility to the channel characteristics than known systems.

### BRIEF DESCRIPTION OF THE DRAWINGS

The invention and additional features, which may be optionally used to implement the invention to advantage, are apparent from and will be elucidated with reference to the drawings described hereinafter and wherein:

FIG. 1A and FIG. 1B are conceptual block diagrams illustrating examples of a transmitter/method of transmission in accordance with the invention, for uplink and downlink transmissions, respectively,

FIG. 2A and FIG. 2B are schematic diagrams illustrating two mapping examples of a method of transmission in accordance with the invention,

FIG. 3A and FIG. 3B are schematic diagrams illustrating in detail the mapping example illustrated in FIG. 2A for two different users, respectively,

FIG. 4A and FIG. 4B are conceptual block diagrams illustrating examples of a receiver/method of reception in accordance with the invention, for uplink and downlink transmissions, respectively,

FIG. 5 is a conceptual block diagram illustrating an example of a system in accordance with the invention.

### DETAILED DESCRIPTION OF THE DRAWINGS

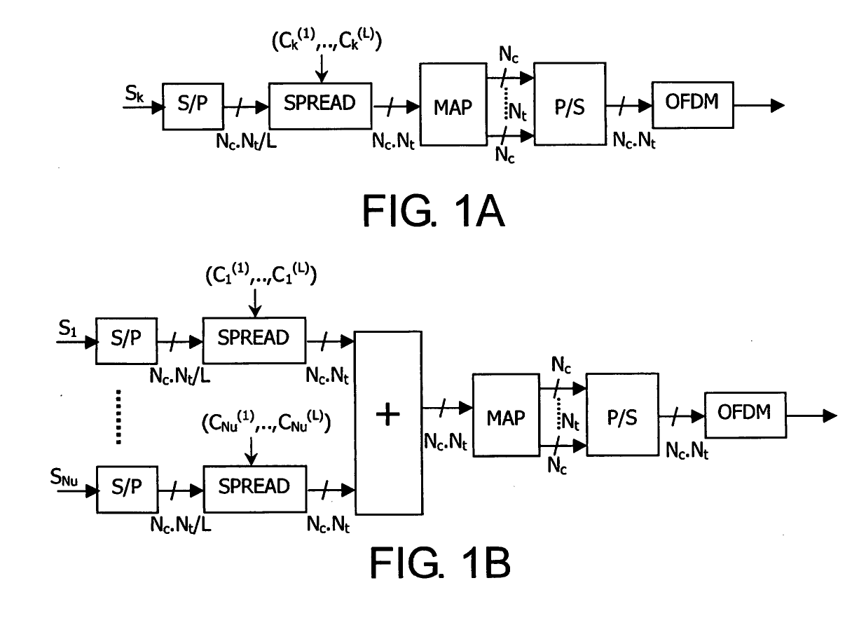

FIG. 1A and FIG. 1B show examples of a part of an MC-CDMA transmitter in accordance with the invention. The transmission system can be any digital multi-user transmission system, such as e.g. a radio mobile communication system. The proposed MC-CDMA scheme is particularly advantageous for the uplink transmissions (FIG. 1A) of a cellular system due to its asynchronous structure.

FIG. 1A illustrates an MC-CDMA transmitter in uplink transmissions. It involves single user equipment e.g. a mobile phone sharing the same bandwidth with a number of users.

MC-CDMA transmission uses multi-carrier Code Division Multiple Access (MC-CDMA). A number of users, denoted Nu, sharing the same bandwidth are assigned predefined spreading codes to spread their data over the whole bandwidth of the channel. The spread data are sent at a set of predefined sub-carriers through the channel. In the example illustrated in FIG. 1A, the user of index k, k=1, . . . ,Nu, is assigned a specific spreading sequence of length L, of successive chips, denoted Cₖ⁽ⁱ⁾, i=1, . . . ,L being the index of the chip in the sequence. The spreading sequence is applied to input data symbols, denoted Sₖ, which are actually already encoded by a source encoder and a channel encoder, not represented. Depending on the system, the spreading sequences assigned to the various users may be orthogonal or near orthogonal to each other but they must have predetermined properties. The number of sub-carriers and time slots for a given frame are denoted N_{c} and Nₜ, respectively. For each user k, the transmitter of FIG. 1A comprises:
spreading means SPREAD for spreading the incoming data symbols Sₖ with the set of predefined spreading sequences (Cₖ⁽¹⁾, . . . ,Cₖ^{(L)}), k=1, . . . ,Nu, of successive chips assigned to user k for producing sequences of spread data symbols including the data symbols multiplied by the chips,
mapping means MAP for mapping the spread data symbols sequences, so that they are assigned to selected sub-carriers among a set of N_{c} predefined sub-carriers and to selected time slots in a predefined periodic time interval comprising Nₜ time slots, so that two successive spread data symbols are assigned to non-successive sub-carriers and in non-successive time slots,
modulating means OFDM for modulating the mapped spread data symbol sequences using Orthogonal Frequency Division Multiplexing (OFDM) for producing OFDM modulated symbols to be transmitted on the selected sub-carriers and in the selected time slots.

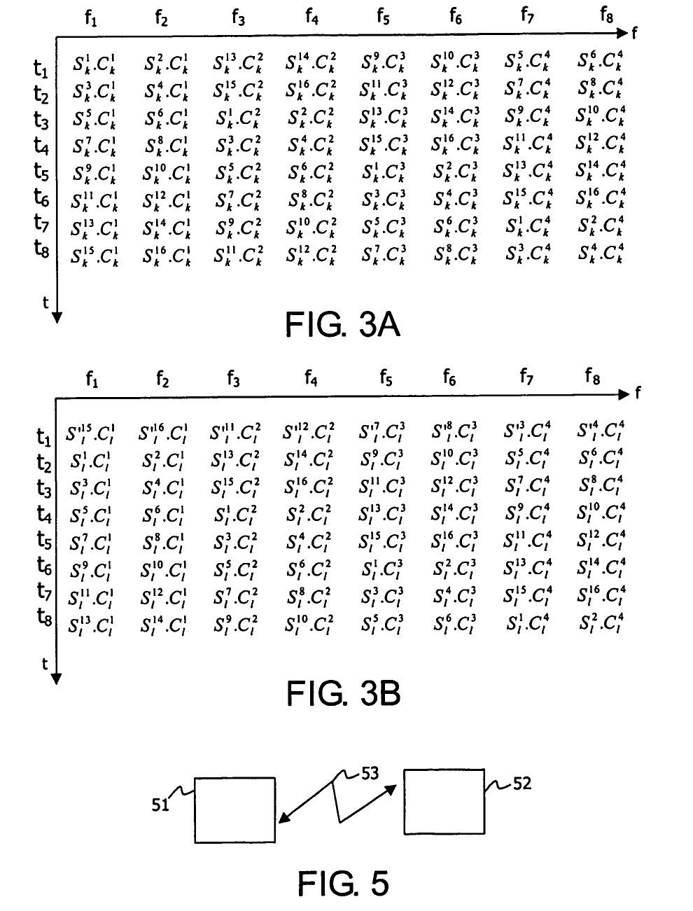

Serial-to-parallel S/P and parallel-to-serial P/S converters are provided at the input of the spreader SPREAD and at the output of the mapping means, respectively, in order to suitably organize the streams of data for the following block operation. All users share the same time-frequency mapping of chips. The spread data symbols are distributed both on various selected sub-carriers and on various selected time slots corresponding to a time-frequency interleaving, which enables to combat both time and frequency selectivity of the channel. Moreover, two successive spread data symbols are assigned to non-successive sub-carriers and in non-successive time slots, which enables to combat even better both time and frequency selectivity of the channel and additionally leads to better robustness to quasi-synchronism. This will be discussed in more detail below with reference to FIG. 3A and FIG. 3B.

Implementation details of the transmission method are given hereafter. For each user k, the serial to parallel converter S/P converts the incoming encoded data symbols Sₖ into a block of N_{c}.Nₜ/L low-rate parallel sub-streams, each of which being dedicated to modulate one of the N_{c} sub-carriers. The output of the serial to parallel converter S/P feeds the spreader SPREAD of length L for spreading the incoming data symbol by the associated spreading waveform of user k, Cₖ⁽ⁱ⁾.

Then, mapping is performed to distribute the N_{c}.Nₜ spread data symbols on the corresponding time-frequency slots. At the mapping output, a parallel-to-serial block P/S guarantees that each block of N_{c} spread symbols is an OFDM input symbol at a given time. The received signal at the base station is the sum of all OFDM modulated signals coming from all users in the system transmitted through their own channels.

FIG. 1B illustrates a transmitter in downlink transmissions in accordance with the invention. The transmitter illustrated in FIG. 1B may be e.g. a base station of a radio mobile communication system, which communicates with several users (downlink transmissions), denoted user l to user Nu. Most of the transmission chain is similar to the transmission chain of FIG. 1A except that the outputs of the spreaders are summed before the mapping. The mapping is the same for all users. At the end of the transmission chain, the Nu sets of corresponding N_{c}.Nₜ OFDM modulated spread symbols are sent through the channel.

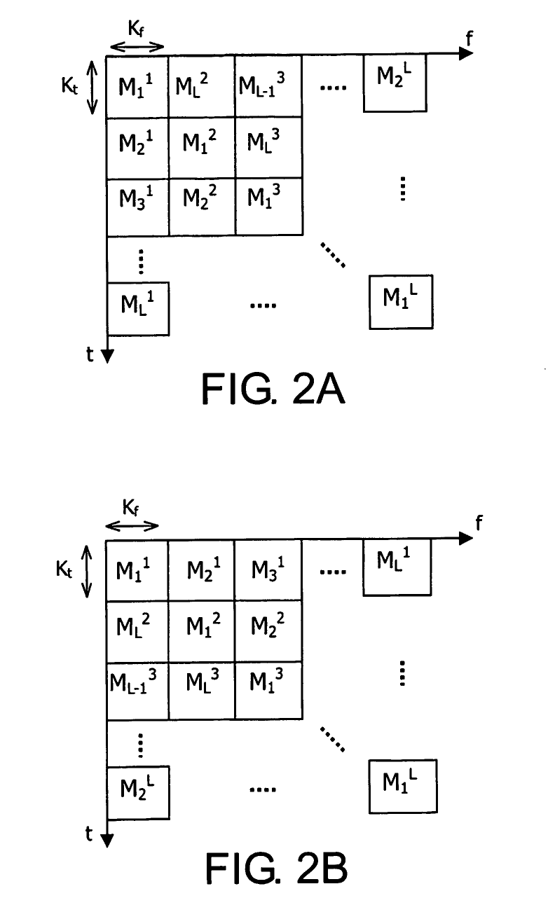

FIG. 2 depicts two mapping matrix examples, which can be advantageously used with respect to the system used to implement the mapping step of the transmission method described above. The mapping example illustrated in FIG. 2A is well adapted to a system, wherein spreading sequences are orthogonal with respect to each other such as e.g. Walsh-Hadamard sequences. The mapping example illustrated in FIG. 2B is well adapted to a system wherein the spreading sequences have specific correlation properties i.e. they have low inter-correlation and autocorrelation profiles such as e.g. Gold sequences.

The number of sub-carriers and slots of a frame are given by N_{c}=K_{f}.L and Nₜ=Kₜ.L where Kₜ and K_{f} denote respectively the time and frequency interleaving depths. The spreading sequences are still of length L. Hence, each sub-matrix Mᵢⁿ of size Kₜ.K_{f} corresponds to the n^{th} chip of the spreading sequence and contains Kₜ.K_{f} data symbols chosen depending on the channel, application and transmission characteristics. Mᵢⁿ is not necessarily a square matrix, and there are L×L sub-matrices Mᵢⁿ so that the L chips of each of the Kₜ.K_{f}L data symbols are represented. With such a mapping, Kₜ.K_{f}L² spread data symbols are simultaneously transmitted in the N_{c}.Nₜ corresponding time-frequency slots. The size of one OFDM symbol is still N_{c}.

FIG. 2A illustrates a mapping example where the sub-matrices are successively distributed in frequency, whereas FIG. 2B illustrates a mapping example where the sub-matrices are successively distributed in time. In both cases, each spread data symbol is distributed on all sub-carriers and in all time slots of a frame, allowing the system to combat efficiently both time and frequency selectivity of the channel. Finally, using the particular mapping of FIGS. 2A and e.g. Walsh-Hadamard spreading sequences, the system is robust to time offsets of 0 to Kₜ−1 chips. Details about this are given below.

FIG. 3A and FIG. 3B represent an implementation example of the mapping matrix of FIG. 2A, for two distinct users k and l, respectively, which have a time offset of 1 chip. In this example, K_{f}=Kₜ=2, N_{c}=Nₜ=8, L=4. The set of N_{c} sub-carriers, denoted f₁ to f₈ are represented on the horizontal axis, whereas the set of Nₜ time slots, denoted t₁ to t₈ are represented on the vertical axis. Incoming data symbols of user k, denoted Sₖⁱ, i=1, . . . ,16 and of user l, denoted Sₗ^{j}, j=1, . . . ,16, are grouped in four symbol-matrices, denoted mᵢ(k) and mᵢ(l), i=1, . . . ,4, respectively. For user k, the four symbol-matrices are:

$$\begin{matrix}{m}_{1} ( k ) = ( \begin{matrix}{S}_{k}^{1} & {S}_{k}^{2} \\ {S}_{k}^{3} & {S}_{k}^{4}\end{matrix} ) & {m}_{2} ( k ) = ( \begin{matrix}{S}_{k}^{5} & {S}_{k}^{6} \\ {S}_{k}^{7} & {S}_{k}^{8}\end{matrix} ) \\ {m}_{3} ( k ) = ( \begin{matrix}{S}_{k}^{9} & {S}_{k}^{10} \\ {S}_{k}^{11} & {S}_{k}^{12}\end{matrix} ) & {m}_{4} ( k ) = ( \begin{matrix}{S}_{k}^{13} & {S}_{k}^{14} \\ {S}_{k}^{15} & {S}_{k}^{16}\end{matrix} )\end{matrix} \\$$

Similarly, for user l the four symbol-matrices are the same as for user k, except that index k is replaced with index 1.

The spreading sequence of chips assigned to user k is denoted (Cₖ⁽¹⁾, Cₖ⁽²⁾, Cₖ⁽³⁾, Cₖ⁽⁴⁾). The one assigned to user l is denoted (Cₗ⁽¹⁾, Cₗ⁽²⁾, Cₗ⁽³⁾, Cₗ⁽⁴⁾). The mapping matrices comprise L×L sub-matrices, denoted Mᵢⁿ(k), i=1, . . . ,L, of size KₜK_{f}, where n=1 . . . L corresponds to the n^{th} chip of the spreading sequence, which sub-matrices comprise KₜK_{f} sub-matrix elements including the data symbols multiplied by the spreading sequence. Theses sub-matrices Mᵢⁿ(k), i=1 . . . L, n=1 . . . L, are, for user k:

$${M}_{i}^{1} ( k ) = ( \begin{matrix}{S}_{k}^{4 ( i - 1 ) + 1} \cdot {C}_{k}^{1} & {S}_{k}^{4 ( i - 1 ) + 2} \cdot {C}_{k}^{1} \\ {S}_{k}^{4 ( i - 1 ) + 3} \cdot {C}_{k}^{1} & {S}_{k}^{4 ( i - 1 ) + 4} \cdot {C}_{k}^{1}\end{matrix} )$$

$${M}_{i}^{2} ( k ) = ( \begin{matrix}{S}_{k}^{4 ( i - 1 ) + 1} \cdot {C}_{k}^{2} & {S}_{k}^{4 ( i - 1 ) + 2} \cdot {C}_{k}^{2} \\ {S}_{k}^{4 ( i - 1 ) + 3} \cdot {C}_{k}^{2} & {S}_{k}^{4 ( i - 1 ) + 4} \cdot {C}_{k}^{2}\end{matrix} )$$

$${M}_{i}^{3} ( k ) = ( \begin{matrix}{S}_{k}^{4 ( i - 1 ) + 1} \cdot {C}_{k}^{3} & {S}_{k}^{4 ( i - 1 ) + 2} \cdot {C}_{k}^{3} \\ {S}_{k}^{4 ( i - 1 ) + 3} \cdot {C}_{k}^{3} & {S}_{k}^{4 ( i - 1 ) + 4} \cdot {C}_{k}^{3}\end{matrix} )$$

$${M}_{i}^{4} ( k ) = ( \begin{matrix}{S}_{k}^{4 ( i - 1 ) + 1} \cdot {C}_{k}^{4} & {S}_{k}^{4 ( i - 1 ) + 2} \cdot {C}_{k}^{4} \\ {S}_{k}^{4 ( i - 1 ) + 3} \cdot {C}_{k}^{4} & {S}_{k}^{4 ( i - 1 ) + 4} \cdot {C}_{k}^{4}\end{matrix} )$$

For user l, the L×L sub-matrices are the same as for user k, except index k is replaced with index 1 and except that for user l, the sub-matrices are time shifted with an offset of one chip in the mapping matrix, as shown in FIG. 3B. Therefore, the first line of the mapping matrix of user l corresponding to the time slot t1 contains spread data symbols of the last row of the previous mapping matrix, denoted S′ₗⁱ, i=15, 16, 11, 12, 7, 8, 3, 4, which does not correspond to the data symbols Sₗ¹ to Sₗ¹⁶, since the sub-matrices are time shifted.

With a time shift not exceeding Kₜ−1, this mapping scheme is more robust to quasi-synchronism, since it allows retrieving the sent data symbols more easily than known schemes, by making use of the correlation properties of the orthogonal spreading sequences, that is:

$$\begin{matrix}∀ k , ∀ l \neq k \\ {\sum }_{i = 1}^{L} {C}_{k}^{i} {C}_{l}^{i} = 0 \\ {\sum }_{i = 1}^{L} {C}_{k}^{i} \cdot {{C}_{k}^{i}}^{*} = 1\end{matrix}$$

For example, de-spreading after demodulation at the receiver side, of the data symbols transmitted at frequency f₁ and in the time slot t₂, can be written as:

$$\begin{matrix}\frac{1}{4} {\sum }_{i = 1}^{4} [ {S}_{k}^{3} \cdot {C}_{k}^{i} + {S}_{l}^{1} \cdot {C}_{l}^{i} ] \times {{C}_{k}^{i}}^{*} = \frac{1}{4} {S}_{k}^{3} {\sum }_{i = 1}^{4} {C}_{k}^{i} \cdot {{C}_{k}^{i}}^{*} + \\ \frac{1}{4} {S}_{l}^{1} {\sum }_{i = 1}^{4} {C}_{l}^{i} \cdot {{C}_{k}^{i}}^{*} \\ = {S}_{k}^{3}\end{matrix}$$

$$since \text{:}$$

$${\sum }_{i = 1}^{4} {C}_{k}^{i} \cdot {{C}_{k}^{i}}^{*} = 1$$

$$and \text{:}$$

$${\sum }_{i = 1}^{4} {C}_{k}^{i} {{C}_{l}^{i}}^{*} = 0$$

Therefore, using a particular mapping in accordance with the invention enables to cope with quasi-synchronism. Actually, the example described above allowing retrieving Sₖ³ only works well for Kₜ×L/2 symbols, that is one line out of 2 in the mapping matrix example of FIG. 3A and FIG. 3B. In all other cases, the results are not exactly equal to the expected data symbols but lead to partial sums with residual terms. These residual terms are easy to eliminate afterwards. Using large enough sub-matrices, the number of cases where the calculations lead to residual terms in addition to the expected data symbols is reduced. Using such sub-matrices also reduces interference due to the occurrence of partial sums, which improves performance.

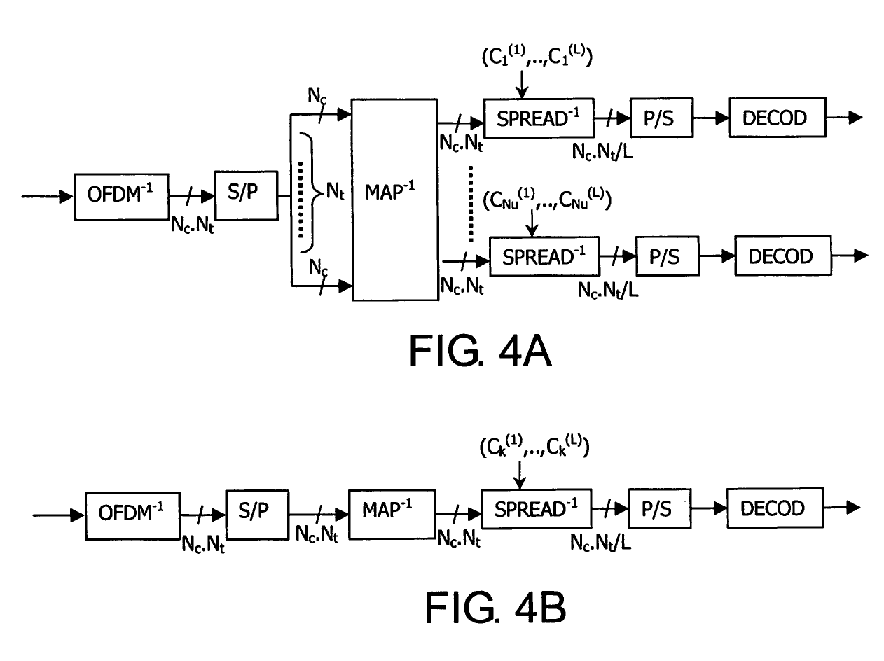

FIG. 4 shows two examples of MC-CDMA receivers in accordance with the invention. FIG. 4A illustrates e.g. a base station receiver of a mobile transmission system in uplink transmissions. The base station receives data encoded by several user equipments of index 1 to Nu, sent via the MC-CDMA mobile transmission system, which uses multi-carrier Code Division Multiple Access (CDMA) and OFDM modulation. The received encoded data are spread with a set of predefined spreading sequences of length L assigned to the various users, denoted (Cₖ(1), . . . ,Cₖ(L)), k being the index of the considered user concerned. The receiver comprises at least:
a demodulator OFDM⁻¹ for demodulating the received multi-carrier data with respect to a set of predefined sub-carriers,
de-mapping means MAP⁻¹ for de-mapping the demodulated data and for retrieving the set of predefined spreading sequences and
de-spreading means SPREAD⁻¹ for de-spreading the set of predefined spreading sequences for retrieving the encoded data sent by the transmitter.

Serial-to-parallel S/P and parallel-to-serial P/S converters are provided at the output of the demodulator OFDM⁻¹ and the de-spreading means SPREAD⁻¹, respectively, in order to suitably organize the output stream of data for the following block operation. At the end of the receiving chain, decoding means DECOD are represented to indicate that the receiver finally needs to decode (source decoding and channel decoding) the de-spread data to retrieve the original data message sent by the transmitter.

FIG. 4B illustrates e.g. a user equipment receiver in downlink transmissions of a mobile communications system. Like block elements as in the receiver of FIG. 4A are indicated by like reference letters. During downlink transmissions, the user equipment of index k only has to de-spread the data sent by the base station and which are destined to its own decoder. Therefore, the user equipment of user k only has to know the spreading sequence of user k that is (Cₖ(1), . . . ,Cₖ(L)).

FIG. 5 shows a system in accordance with the invention comprising a transmitter 51, a receiver 52 and a transmission channel 53, for transmitting data from the transmitter to the receiver via the transmission channel. Depending on the system and the kind of transmissions performed, the transmitter and receiver may alternatively be the same devices. In a mobile communication system, typically, the user equipment would be the receiver and the base station would be the transmitter during downlink transmissions, whereas in uplink transmissions, the base station would be the receiver and the user equipment the transmitter. In uplink transmissions, the transmitter may be similar in design to the MC-CDMA transmitter depicted in FIG. 1A, and the receiver may be similar in design to the MC-CDMA receiver depicted in FIG. 4A. In downlink transmissions, the transmitter may be of similar design to the MC-CDMA transmitter depicted in FIG. 1B and the receiver may be of similar design to the MC-CDMA receiver depicted in FIG. 4B.

The drawings and their description hereinbefore illustrate rather than limit the invention. It will be evident that there are numerous alternatives, which fall within the scope of the appended claims. In this respect, the following closing remarks are made.

There are numerous ways of implementing functions by means of items of hardware or software, or both. In this respect, the drawings are very diagrammatic, each representing only one possible embodiment of the invention. Thus, although a drawing shows different functions as different blocks, this by no means excludes that a single item of hardware or software carries out several functions. Nor does it exclude that an assembly of items of hardware or software, or both carries out one function.

Any reference sign in a claim should not be construed as limiting the claim. Use of the verb “to comprise” and its conjugations does not exclude the presence of elements or steps other than those stated in a claim. Use of the article “a” or “an” preceding an element or step does not exclude the presence of a plurality of such elements or steps.

1. Method of transmitting data symbols using multi-carrier Code Division Multiple Access (MC-CDMA) for accessing a transmission system, the method comprising:
spreading the data symbols with a set of predefined spreading sequences of successive chips for producing sequences of spread data symbols including the data symbols multiplied by the chips,
mapping the spread data symbol sequences so that they are assigned to selected sub-carriers among a set of predefined sub-carriers and to selected time slots in a predefined periodic time interval,
modulating the mapped spread data symbol sequences using Orthogonal Frequency Division Multiplexing (OFDM) for producing OFDM modulated symbols to be transmitted on the selected sub-carriers and in the selected time slots,
wherein two successive spread data symbols are assigned to non-successive sub-carriers and in non-successive time slots.

2. Method as claimed in claim 1, wherein the step of mapping includes defining a mapping matrix of size KₜL×K_{f}L, L being the length of the predefined spreading sequences, Kₜ and K_{f} denoting time and frequency interleaving depths respectively, KₜL representing the number of time slots in the periodic time interval and K_{f}L representing the number of sub-carriers in the set of predefined sub-carriers, an OFDM modulated symbol being transmitted in a time slot and transporting K_{f}L spread data symbols, wherein the mapping matrix comprises L×L sub-matrices, denoted Mᵢⁿ, i=1 . . . L, of size KₜK_{f}, where n=1 . . . L corresponds to the n^{th} chip of the spreading sequence, which sub-matrices comprise KₜK_{f} sub-matrix elements corresponding to spread data symbols, for simultaneously transmitting KₜK_{f}L² spread data symbols on the corresponding selected sub-carriers and in the corresponding selected time slots and wherein the positions of the sub-matrix elements are predetermined with respect to quality criteria depending on the transmission system.

3. Method as claimed in claim 2, wherein the sub-matrices are distributed in the mapping matrix in order that the sub-matrices Mᵢⁿ corresponding to a same n^{th} chip are assigned to same set of K_{f} successive sub-carriers.

4. Method as claimed in claim 2, wherein the sub-matrices are distributed in the mapping matrix in order that the sub-matrices Mᵢⁿ corresponding to a same n^{th} chip are assigned to a same set of Kₜ successive time slots.

5. Transmitter for transmitting data symbols using multi-carrier Code Division Multiple Access (CDMA) for accessing a transmission system, comprising:
spreading means for spreading the data symbols with a set of predefined spreading sequences of successive chips for producing sequences of spread data symbols including the data symbols multiplied by the chips,
mapping means for mapping the spread data symbol sequences so that they are assigned to selected sub-carriers among a set of predefined sub-carriers and to selected time slots in a predefined periodic time interval,
modulating means for modulating the mapped spread data symbol sequences using Orthogonal Frequency Division Multiplexing (OFDM) for producing OFDM modulated symbols to be transmitted on the selected sub-carriers and in the selected time slots,
wherein two successive spread data symbols are assigned to non-successive sub-carriers and in non-successive time slots.

6. Method of receiving multi-carrier data encoded by a transmitter and sent via a transmission system using multi-carrier Code Division Multiple Access (CDMA) for accessing the transmission system, the encoded data being OFDM modulated after being spread with a set of predefined spreading sequences, the method comprising:
demodulating the received multi-carrier data with respect to a set of predefined sub-carriers,
de-mapping the demodulated data for retrieving the set of predefined spreading sequences and
de-spreading the set of predefined spreading sequences for retrieving the encoded data sent by the transmitter.

7. Receiver for receiving data encoded by a transmitter and sent via a transmission system using multi-carrier Code Division Multiple Access (CDMA) for accessing the transmission system, the data being OFDM modulated after being spread with a set of predefined spreading sequences, the receiver comprising:
a demodulator for demodulating the received multi-carrier data with respect to a set of predefined sub-carriers,
de-mapping means for de-mapping the demodulated data for retrieving the set of predefined spreading sequences and
de-spreading means for de-spreading the set of predefined spreading sequences for retrieving the encoded data sent by the transmitter.
Computer program product for a transmitter computing a set of instructions, which when loaded into the transmitter, causes the transmitter to carry out the method as claimed in claim 1.

8. Computer program product for a receiver computing a set of instructions, which when loaded into the receiver, causes the receiver to carry out the method as claimed in claim 6.

9. Transmission system comprising at least a transmitter and a receiver for transmitting data from the transmitter to the receiver using multi-carrier Code Division Multiple Access (CDMA) for accessing the transmission system, the transmitted data being modulated using Orthogonal Frequency Division Multiplexing (OFDM) after being spread with a set of predefined spreading sequences of consecutive chips, wherein two successive chips of the predefined sequences are transmitted on non-successive carriers and in non-successive time intervals.
